(19) United States
(12) Patent Application Publication
(10) Pub. No.: US 2011/0074808 A1
(43) Pub. Date: Mar. 31, 2011

(54) Full Color Gamut Display Using Multicolor Pixel Elements

(76) Inventors: Jiandong Huang, Vancouver, WA (US); Scott J. Daly, Kalama, WA (US); Apostolos T. Voustas, Portland, OR (US); Akinori Hashimura, Vancouver, WA (US); Xiao-fan Feng, Vancouver, WA (US)

(21) Appl. No.: 12/750,495

(22) Filed: Mar. 30, 2010

Related U.S. Application Data
(63) Continuation-in-part of application No. 12/646,585, filed on Dec. 23, 2009.
Application No. 12/646,585 is a continuation-in-part of application No. 12/635,349, filed on Dec. 10, 2009.
Application No. 12/635,349 is a continuation-in-part of application No. 12/621,567, filed on Nov. 19, 2009.
Application No. 12/621,567 is a continuation-in-part of application No. 12/614,368, filed on Nov. 6, 2009.
Application No. 12/614,368 is a continuation-in-part of application No. 12/568,522, filed on Sep. 28, 2009.

(51) Int. Cl. G09G 5/02

(52) U.S. Cl. 345/590

(57) ABSTRACT

A display device is provided that includes a plurality of pixels, where each pixel includes a single subpixel. In a first aspect, a single subpixel is able to sequentially generate a plurality of (e.g., at least three) primary colors. As a result of the single subpixel, the display is able to supply a gamut of colors including at least 3 primaries colors. For example, the sequential generation of the 3 primary colors may involve operating the subpixel in a time division multiplex (TDM) mode, and a primary combination color is supplied in response to the subpixel generating 2 primary colors in respective TDM subframes. When the pixel includes at least two neighboring subpixels, the pixel may additionally be operated in a spatial division multiple (SDM) mode or in the TDM mode.

### RELATED APPLICATION

The application is a Continuation-in-Part of a pending application entitled, MULTIPLEXED DISPLAY USING MULTICOLOR PIXELS, invented by Aki Hashimura et al., Ser. No. 12/646,585, filed on Dec. 23, 2009, Attorney Docket No. SLA2686;

which is a Continuation-in-Part of a pending application entitled, PLASMONIC DEVICE TUNED USING LIQUID CRYSTAL MOLECULE DIPOLE CONTROL, invented by Tang et al., Ser. No. 12/635,349, filed on Dec. 10, 2009, Attorney Docket No. SLA2711;
which is a Continuation-in-Part of a pending application entitled, PLASMONIC DEVICE TUNED USING ELASTIC AND REFRACTIVE MODULATION MECHANISMS, invented by Tang et al., Ser. No. 12/621,567, filed on Nov. 19, 2009, Attorney Docket No. SLA2685;

which is a Continuation-in-Part of a pending application entitled, COLOR-TUNABLE PLASMONIC DEVICE WITH A PARTIALLY MODULATED REFRACTIVE INDEX, invented by Tang et al., Ser. No. 12/614,368, filed on Nov. 6, 2009, Attorney Docket No. SLA2684.

The instant application is also a Continuation-in-Part of a pending application entitled, FULL COLOR RANGE INTERFEROMETRIC MODULATION, invented by Aki Hashimura et al., Ser. No. 12/568,522, filed on Sep. 28, 2009, Attorney Docket No. SLA2620. All the above-referenced applications are incorporated herein by reference.

### BACKGROUND OF THE INVENTION

1. Field of the Invention

This invention generally relates to electronic color displays and, more particularly, to a system and method for generating a full range of colors using multicolor subpixels.

2. Description of the Related Art

FIG. 1 is a diagram depicting a color gamut anchored by three primary colors (prior art). Most of modern displays require three primary colors, e.g., R(red), G(green) and B(blue) to create colored images. With combinations of the three primary color pixels, some “in-between” colors in the triangle color gamut (between R, G, and B points) can be reproduced. This approach is widely used in today's liquid crystal display (LCD) and plasma displays.

However, the limit of three primary color pixel for each ‘display unit pixel (DUP)’ or pixel, which limits the achievable spatial resolution. In addition, most of current display technologies require strong backlight illuminations or strong emissive pixels (e.g., plasma and organic light emitting diodes (OLEDs)) for large dynamic and high contrast display effects. Those high luminous backlight sources and highly emissive pixels often require high power consumptions, which is not suitable for portable devices with power supplies from batteries.

Reflective display or color-tunable device technology is attractive primarily because it consumes substantially less power than LCDs and OLED displays. A typical LCD used in a laptop or cellular phone requires internal (backlight) illumination to render a color image. In most operating conditions the internal illumination that is required by these displays is in constant competition with the ambient light of the surrounding environment (e.g., sunlight or indoor overhead lighting). Thus, the available light energy provided by these surroundings is wasted, and in fact, the operation of these displays requires additional power to overcome this ambient light. In contrast, reflective display technology makes good use of the ambient light and consumes substantially less power.

Recently, MEMS reflective displays have been developed using interferometric light modulation three subpixel (red, green, and blue (RGB)) devices. Advantageously, these displays do not require backlighting. Other colors are generated by mixing of these three primary colors. Moreover, grayscale images can be generated using spatial or temporal addressing of the three subpixels. However, since each pixel is divided into three subpixels, the total reflectance for a primary color can be no more than 33%. It would be much more desirable if a single pixel could generate all colors with 100% reflectivity.

FIG. 2 is a MEMS light valve switch expressed as a spring-damping-capacitor model (prior art). Using parallel-plate MEMS technology, a color can be tuned to a desired reflection by applying a voltage between the reflective movable plate and a transparent fixed-position actuation electrode by varying the air gap distance. However for electrostatic force, a non-linear state known as “pull-in” effect can occur at approximately one-third the air gap distance, where the movable plate snaps down to the actuating electrode. This effect limits the tuning range to less than one-third the gap distance, which is the reason three subpixels are conventionally required to generate the three primary colors.

When a voltage is applied to each side of the parallel-plate capacitor, the movable plate is pulled toward the bottom plate by attraction of Coulomb force:

$${F}_{elec} = \frac{{CV}^{2}}{{( g - d )}^{2}}$$

where C is the capacitance area, V is the applied voltage, g is the initial gap, and d is the displacement distance. At sufficiently small displacements, the deflection reaches an equilibrium position due to opposing Hooke's Law:

F_{mech}=kd

However, when the displacement of the movable plate is larger than one-third the initial gap, i.e. d>g/3, the Hooke's force is not strong enough to balance the Coulomb force attraction. Therefore at this point, known as the pull-in voltage, the movable plate eventually snaps down to the non-equilibrium state.

The pull-in voltage is expressed as the following:

$${V}_{pull \text{-} in} = \sqrt{\frac{8}{27} \frac{{kg}^{3}}{ɛ A}}$$

where ∈ is the electrical permittivity of the material, and A is the area of the parallel-plate capacitor.

By solving the pull-in voltage issue, MEMS pixels can be designed to selectively reflect light with peak wavelengths in the whole visible spectral ranges. The peak wavelengths are tunable as the function of air gap lengths,

λ_{Peak}=f(d) Equation 1

In which λ_{Peak} is the peak wavelength, f(d) is the correlation function (depending on the MEMS design), and d is the air gap lengths for each MEMS pixel.

From Equation 1, it can be clearly seen that with just one subpixel, most of the standard colors through the visible spectral range can be generated.

The key advantage for the reflection based MEMS displays is the low power consumptions. Two major factors contribute to the low power consumptions: (1) no back light sources are required, which is the major factor; (2) for MEMS pixels, power consumptions only occur at switching transitions periods between different air space lengths, which are typically very short compared to the whole color duty cycles (decided by the frame rates) for well-designed MEMS pixels. The second factor can be explained by energy changes in capacitance during MEMS pixel operations. At stable states, the energy stored in MEMS capacitances is

E=U²×C(d)×0.5 Equation 2

Where E is the energy stored in the MEMS pixels, U is the biased voltages, and C(d) is the capacitance as the function of thickness d. It is clear that the power consumption is near zero (since the time derivatives of E(t) is almost zero) when the MEMS pixels are at a stable state. Only when the MEMS pixels are switched from position d₁ to d₂ by applied voltage changes, both U and C vary, leading to power consumptions E(d₁)-E(d₂). The near-zero power consumptions for stable states make the display very advantageous for showing still images (e.g., e-paper applications), as compared with other types of displays. Further it can be used for video displays due to the fast achievable switching speeds at the expense of power consumptions.

FIG. 3A is a schematic diagram of a MEMS pixel tuned to reflect the primary color of green (prior art).

FIG. 3B is a graph depicting the tunability of an ideal MEMS pixel, able to reflect any single color within the whole visible color range.

A number of other reflective display technologies have been developed, such as electrophoretic, electrowetting, and electrochromic displays. These display technologies, as well as the interference-based MEMS, all have disadvantages or challenges that must be overcome to obtain greater commercial success. Many existing technologies rely upon phenomena that are intrinsically slow. For example, electrophoretic or electrochemical techniques typically require particles to drift or diffuse through liquids over distances that create a slow response. Some other technologies require high power to operate at video rates. For example, many reflective displays must switch a large volume of material or chromophores from one state to another to produce an adequate change in the optical properties of a pixel. At video switching rates, currents on the order of hundreds of mA/cm² are necessary if a unit charge must be delivered to each dye molecule to affect the change. Therefore, display techniques that rely on reactions to switch dye molecules demand unacceptably high currents for displaying video. The same holds true for electrochromic displays.

A second challenge for reflective displays is the achievement of high quality color. In particular, most reflective display technologies can only produce binary color (color/black) from one material set. To create a full color spectrum at least three sub-pixels, using different material sets, must be used when employing a side-by-side sub-pixel architecture with fixed colors. This limits the maximum reflected light for some colors to about ⅓, so that the pixels of this type cannot produce saturated colors with a good contrast.

Some reflective displays face reliability problem over a long lifetime. In particular, to sustain video rate operation for a few years requires at least billions of reversible changes in optical properties. Achieving the desired number of cycles is particularly difficult in reflective displays using techniques based on chemical reactions, techniques that involve mixing and separation of particles, or MEMS technology that involves repeated mechanic wear or electric stress.

FIG. 4 is a partial cross-sectional view of nanoplasmonic display in which the color tuning is accomplished by electrical modulation of the refractive index of an electro-optical material such as a liquid crystal (pending art). Details of the device 100 can be found in the pending application entitled, COLOR-TUNABLE PLASMONIC DEVICE WITH A PARTIALLY MODULATED REFRACTIVE INDEX, invented by Tang et al., Ser. No. 12/614,368. Because of the limited refractive index (n) change of dielectric 106 materials such as liquid crystal, the color tuning range of a device using just this tuning modulation means is very limited. Thus, the device of FIG. 4 uses an additional color tuning mechanism, as described below.

FIG. 5 is a graph simulating the relationship between resonant wavelength change and refractive index for a liquid crystal material surrounding an Ag nanoparticle with a diameter of 80 nanometers. For example, the highest birefringence liquid crystal commercially available only has a Δn of 0.3, which provides a tuning range of only 80 nm, based on the simulation result in FIG. 5. Research labs have reported liquid crystals with a Δn as high as 0.79, but the performance of such materials is not guaranteed. Besides, these materials may not have the appropriate response time or threshold voltage required for the nanoplasmonic display application.

Retuning to FIG. 4, the color tuning range of a plasmonic device can be improved with the addition of a second dielectric layer 104, which has a refractive index that is non-responsive to an electric field.

It would be advantageous if a practical pixel design existed that permitted a wider range of colors.

It would be advantageous if a pixel were able to generate a full gamut of colors using less than three subpixels.

It would be advantageous if a pixel were able to generate a broader range of combination colors by using more than 3 primary colors.

### SUMMARY OF THE INVENTION

Provided herein are a system and method that permit a reflective display pixel to generate a larger color gamut, while consuming less power. For higher resolution applications where a primary combination color is required, the two primary color subfields are generated using either one or two subpixels sequentially multiplexed in time division multiplexing (TDM) mode. For lower resolution applications, neighboring subpixels simultaneously generate primary colors in a spatial division multiplexing (SDM) mode. Even in the low resolution modes, the achievable spatial resolution for each pixel is still higher than for a conventional three-subpixel display. The TDM mode requires constant switching of the subpixels to create colorful images, and consumes more energy than the SDM mode. In the SDM mode, once an image is set, it can be held for long time without consuming power, making this mode good for static displays, such as book readers and other e-paper.

Accordingly, a display device is presented that utilizes a method for generating a full color gamut. In one aspect, a display includes a plurality of pixels, and each pixel includes a single subpixel. A pixel, as defined herein, is a physical element occupying a space (i.e. a spatial element) capable of showing any color needed to display image. A subpixel is a physical element occupying a space that forms a part of a pixel, able to generate at least one primary color. In the present device, a single subpixel is able to sequentially generate a plurality of (e.g.; at least three) primary colors. A primary color exhibits a single wavelength peak in the visible spectrum of light. As a result of the single subpixel, the display is able to supply a gamut of colors including at least 3 primaries colors. For example, the sequential generation of the 3 primary colors may involve operating the subpixel in a time division multiplex (TDM) mode, and a primary combination color is supplied in response to the subpixel generating 2 primary colors in respective TDM subframes. A primary combination color is the “in-between” color perceptible to human vision as the result of “merging” two primary colors. To take a simple example, the primary combination color of orange resulting from the primary colors of red and yellow.

In another aspect, the pixel includes at least two neighboring subpixels which can be operated in the spatial division multiplex (SDM) mode, and primary combination colors can be supplied in response to the first and second subpixels simultaneously generating primary colors in the SDM mode. If the first subpixel is capable of sequentially generating at least 2 primary colors, then it can also be operated the TDM mode, and a primary combination color can be supplied in response to the first subpixel generating 2 primary colors in respective TDM subframes. If the second subpixel capable of sequentially generating 2 primary colors, then a primary combination color can be supplied in response to the first subpixel generating 2 primary colors in respective TDM subframes, the second subpixel generating 2 primary colors in respective TDM subframes, the first and second pixels each generating a primary color in respective TDM subframes, or the first and second subpixels generating primary colors in the SDM mode.

Additional details of the above-described method and multicolor gamut display are provided below.

### BRIEF DESCRIPTION OF THE DRAWINGS

FIG. 1 is a diagram depicting a color gamut anchored by three primary colors (prior art).

FIG. 2 is a MEMS light valve switch expressed as a spring-damping-capacitor model (prior art).

FIG. 3A is a schematic diagram of a MEMS pixel tuned to reflect the primary color of green (prior art).

FIG. 3B is a graph depicting the tunability of an ideal MEMS pixel, able to reflect any single color within the whole visible color range.

FIG. 4 is a partial cross-sectional view of nanoplasmonic display in which the color tuning is accomplished by electrical modulation of the refractive index of an electro-optical material such as a liquid crystal (pending art).

FIG. 5 is a graph simulating the relationship between resonant wavelength change and refractive index for a liquid crystal material surrounding an Ag nanoparticle with a diameter of 80 nanometers.

FIG. 6 is a schematic block diagram of a multicolor display.

FIG. 7 is schematic block diagram of a first variation of the multicolor display of FIG. 6.

FIGS. 8A, 8B, and 8C depict the relationship being a MEMS subpixel air gap, tuning voltage, and color wavelength.

FIG. 9 is a color gamut depicting the broader range of both primary and primary combinations colors available with the use of multicolor subpixels.

FIG. 10 is a diagram depicting the TDM mode of operation to generate primary and primary combination colors.

FIG. 11 is a diagram depicting the SDM mode of operation to generate primary and primary combination colors.

FIGS. 12A and 12B respectively contrast a 9-subpixel pixel with a conventional three-subpixel (RGB) pixel.

FIG. 13 is a flowchart illustrating a method for generating a full color gamut in a display device.

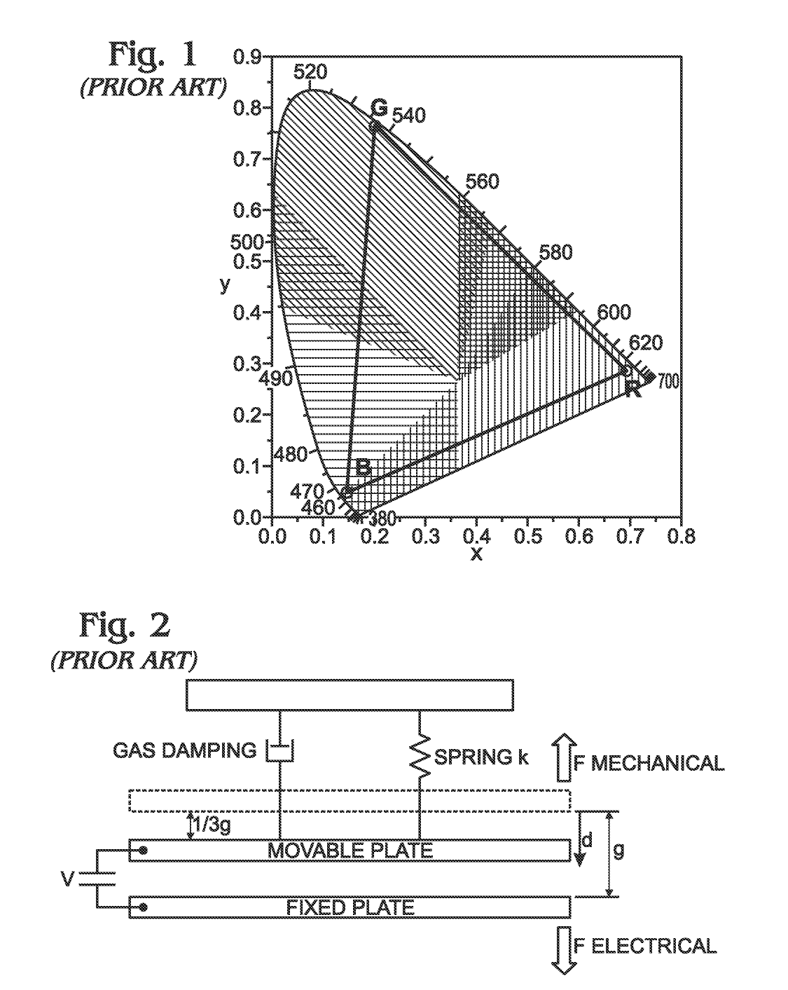

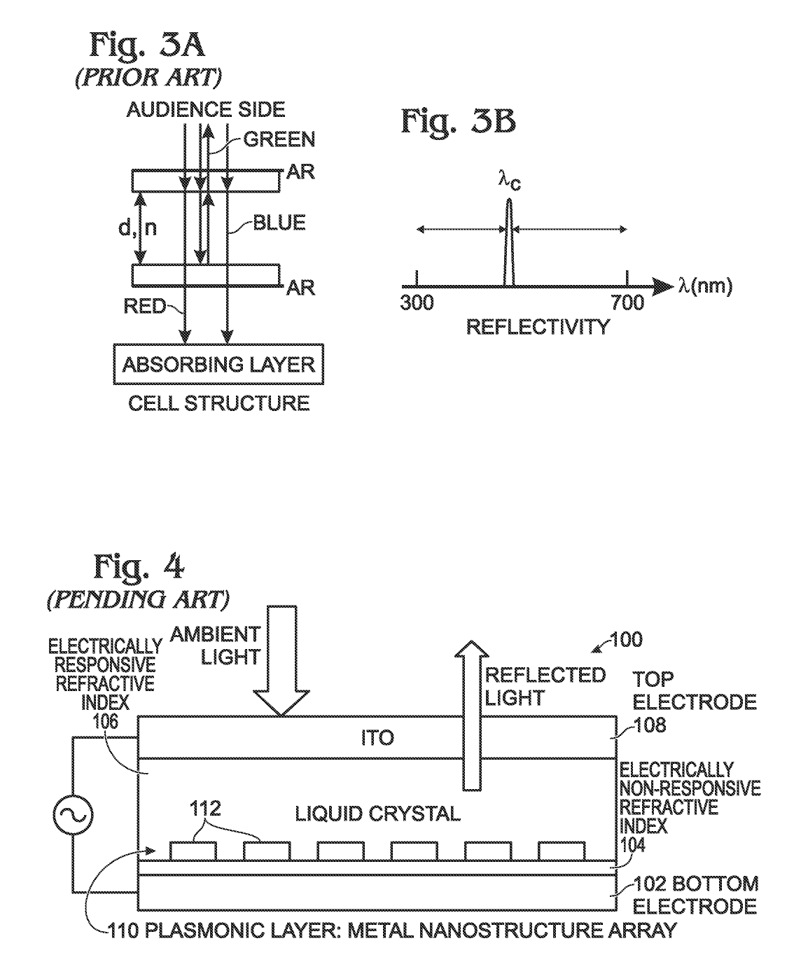

### DETAILED DESCRIPTION

FIG. 6 is a schematic block diagram of a multicolor display. The display 600 comprises at least one pixel 602 supplying a gamut of colors including at least 3 primaries colors. Shown are pixels 602a through 602n, where n is a variable not limited to any particular value. Each pixel 602 includes a single subpixel 604 capable of sequentially generating a plurality of primary colors. A primary color exhibits a single wavelength peak in the visible spectrum of light. A pixel, as defined herein, is a physical element occupying a space (i.e. a spatial element) capable of showing any color needed to display image. Generally, a subpixel is a physical element occupying a space that forms a part of a pixel, able to generate at least one primary color. For example, each subpixel may be a tunable plasmonic device or a tunable interferometric modulation device. Examples of tunable plasmonic and Interferometric modulation devices can be found in the parent applications referenced above in the Related Applications Section.

Each subpixel 604 in the display 600 is capable of sequentially generating at least 3 primary colors, although more than 3 primary colors are possible. For example, each subpixel may be capable of generating red, green, and blue (RGB) primary colors, or cyan, magenta, and yellow (CMYK) primary colors. Each subpixel 604 is capable of operation in a time division multiplex (TDM) mode. Then, each pixel 602 is able to supply primary combination colors in response to the subpixel 604 generating 2 primary colors in respective TDM subframes. A primary combination color is the “in-between” color perceptible to human vision as the result of “merging” two primary colors. To take a simple example, the primary combination color of orange results from the primary colors of red and yellow. A subframe or subfield is a temporal slice of a frame (or field), so that multiple subframes=1 frame. A frame or field is one entire spatial image. For example, a display image that changes over a time interval (e.g., multiple frame intervals) may be referred to as a video image.

FIG. 7 is schematic block diagram of a first variation of the multicolor display of FIG. 6. In this aspect, each pixel 602 includes two (adjacent or neighboring) subpixels 604, where at least one subpixel is capable of sequentially generating a plurality of primary colors. Shown are subpixels 604a and 604b. However, it should be understood that each pixel may alternately include more than two subpixels (see FIG. 12A). In one aspect, the first subpixel 604a is capable of sequentially generating at least 2 primary colors and the second subpixel 604b is capable of generating at least 1 primary color. Thus, between the two subpixels 604a/604b, at least 3 primary colors can be generated. Primary combination colors can be generated by operating the first subpixel 604a in the TDM mode, and by operating the first and second subpixels 604a/604b in the TDM mode.

In another aspect, the first subpixel 604a is capable of generating 2 primary colors in respective TDM subframes and the second subpixel 604b is also capable of generating 2 primary colors in respective TDM subframes. Then, each pixel 602 supplies primary combination colors in response to the first subpixel 604a generating 2 primary colors in respective TDM subframes, the second subpixel generating 2 primary colors in respective TDM subframes, and the first and second subpixels each generating a primary color in respective TDM subframes.

Further, the first and second subpixels 604a/604b may be capable of operation in the spatial division multiplex (SDM) mode, and each pixel 602 additionally supplies primary combination colors in response to the first and second pixel elements simultaneously generating a primary color in the SDM mode. It should also be noted that the display of FIG. 7 may generate both primary and primary combination colors using two (or more) subpixels in just the SDM (but not the TDM) mode.

Referencing either FIG. 6 or FIG. 7, in one aspect each pixel 602 includes a control interface 606 to accept framing signals. Each framing signal includes commands for selecting a subpixel primary color.

Each subpixel 604 is capable of changing the primary color being generated in response to the framing signals. For simplicity a single control interface is shown for each row of the display. However, it should be understood that each pixel may be individually controlled using a combination row and column (not shown) control interfaces to create an XY control matrix, as is well understood in the art.

Referencing FIG. 7 in particular, in another aspect each pixel 602 is able to supply a primary combination color in response to the first and second pixel elements simultaneously generating a primary color in the SDM mode, over a time duration lasting a plurality of frames. Specifically, a primary color or primary combination color may be generated over a plurality of frames in response to a single control signal (e.g., without changing the control signals or switching the subpixels). Such an arrangement conserves power and makes to display suitable for portable e-book applications.

It should be noted that when the subpixels of FIG. 6 or 7 are parked in the off state, they typically generate a UV or IR wavelength color, which is perceived as black.

### Functional Description

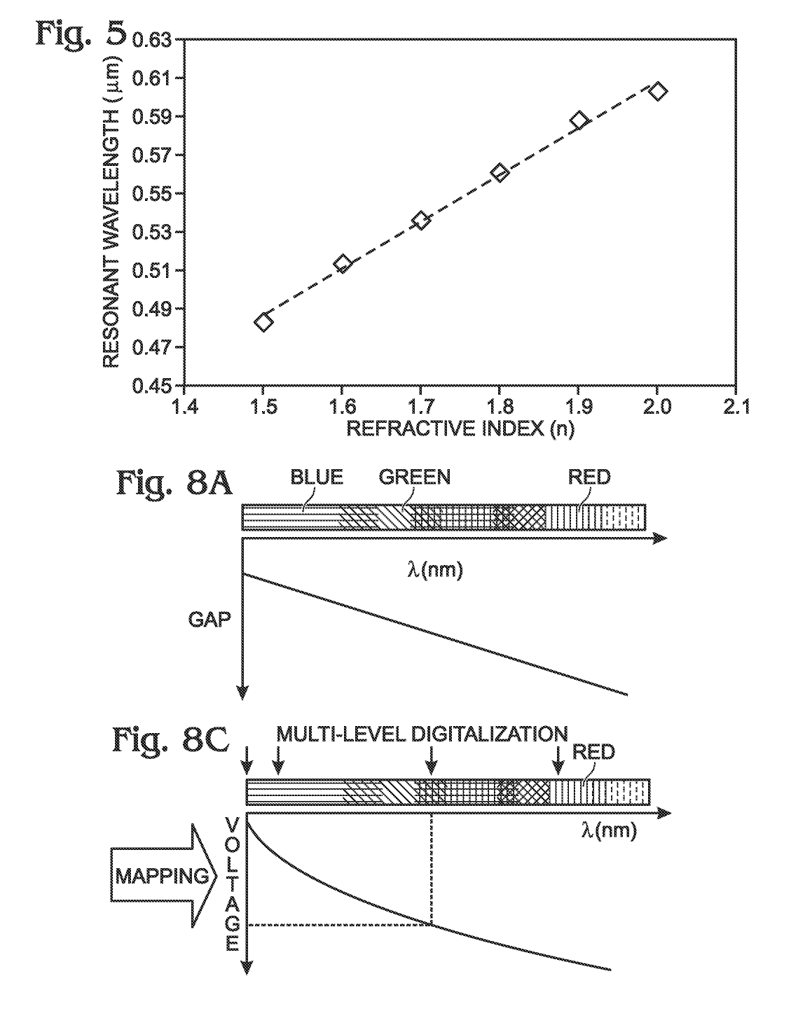

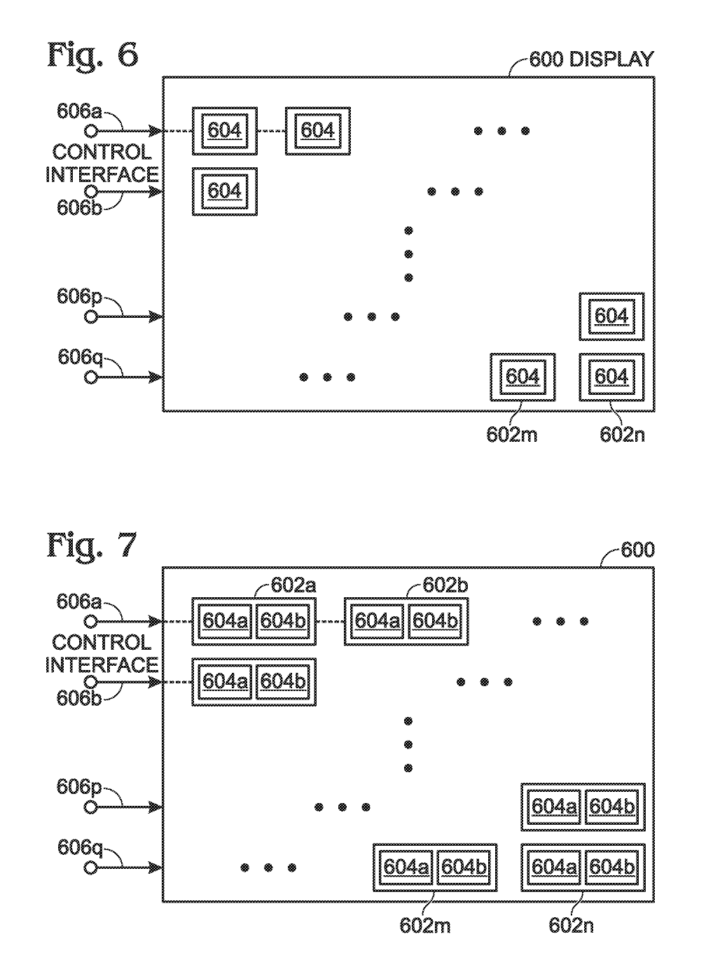

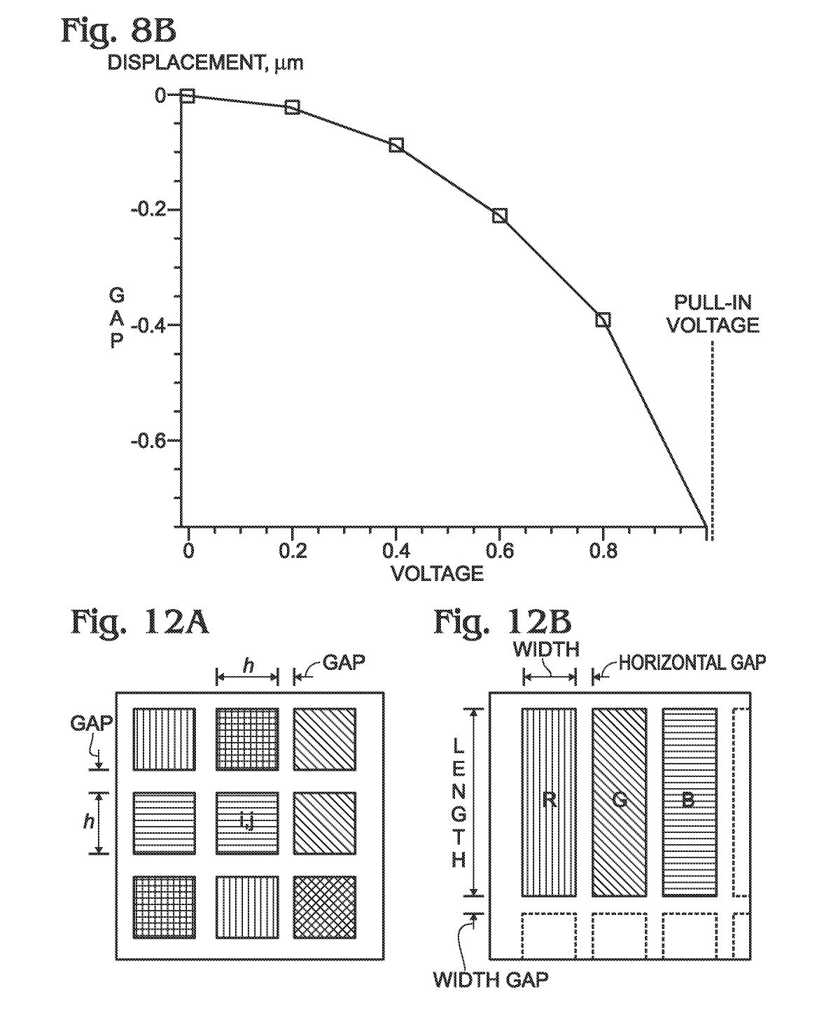

FIGS. 8A, 8B, and 8C depict the relationship being a MEMS subpixel air gap, tuning voltage, and color wavelength. By tuning the air gaps of MEMS subpixels through the adjustment of bias voltages, more colors than just R, G, and B can be generated. It is desirable to digitalize the available colors to λ₁, λ₂, . . . , λ_{N} with corresponding bias voltages as V₁, V₂, . . . , V_{N}. The larger the number of digitalization levels, the higher the spectral resolution that can be achieved. However, the achievable spectral resolution is also limited by the achievable bandwidth, Δλ, of the reflection spectra, which is determined mainly by the optical designs of the pixel structures. The maximum digitalization level N can be roughly estimated as

N=(700 nm−400 nm)/Δλ Equation 3

Further, as described above, hybrid TDM and SDM methods can select primary colors from λ₁, λ₂, . . . , λ_{N} as primary colors used to further generate primary combination colors.

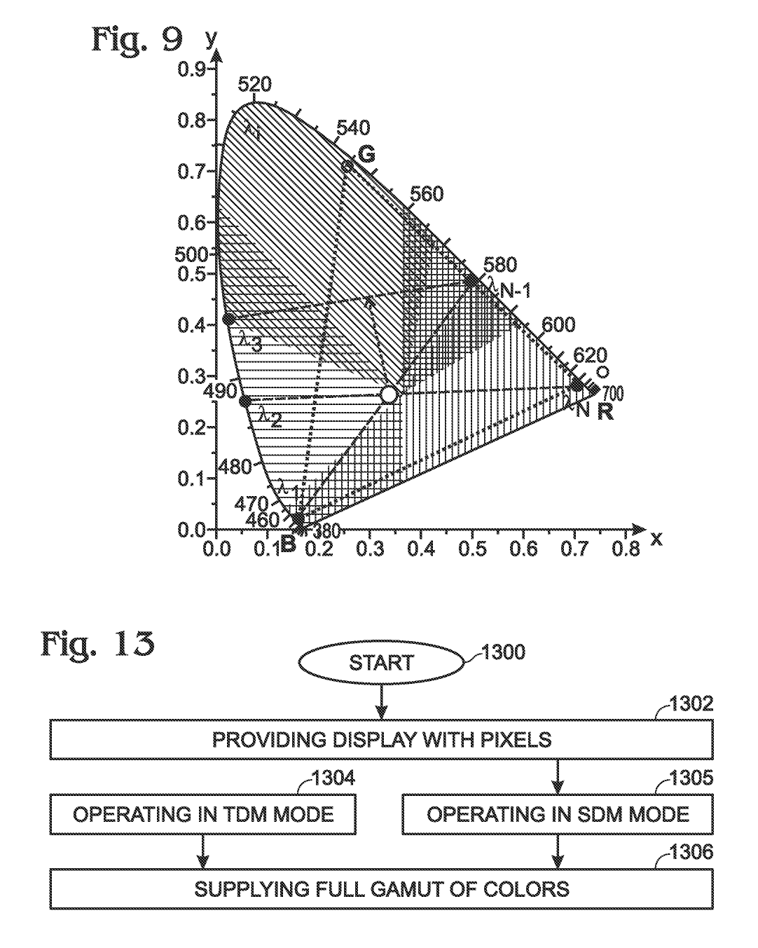

FIG. 9 is a color gamut depicting the broader range of both primary and primary combinations colors available with the use of multicolor subpixels. Colors that can be generated from the reflection of ambient light by MEMS pixels can be digitalized into a serial of colors as λ₁, λ₂, . . . , λ_{N}, which can be further mapped on the color map shown in FIG. 9. Compared with the color gamut associated with a three fixed primary color display (the dotted line triangle), the number of primary combination colors, as represented by colors along the dashed lines, and the overall color gamut for multiple-level digitalized MEMS displays is much wider.

In principle, almost any color in the wider gamut can be decomposed into the combinations of two primary colors that can be created directly by the tuning of reflection spectra of MEMS pixels. However, due to the limited number of digitalization of wavelengths (as shown by Equation 3), only certain color combinations can fully reconstruct the desired colors. For example, as shown in FIG. 9, the white color marked with the open circle can be decomposed into any combinations of two primary colors (marked as solid circles and linked by the dashed lines crossing the circle). But only the combination of λ₁ and λ_{N-1} can fully reconstruct the desired white color in the available quantized wavelength subset λ₁, λ₂, . . . , λ_{N}. Increasing the number of wavelength digitalization can increase the available pairs of primary colors to fully reconstruct the desired colors, but from Equation 3, one can see the limitations on this approach. In addition, it is necessary to adaptively select different pairs of two primary colors as the desired colors “moves” inside the full color gamut, as indicated by the dotted-line arrow, in which the pair of (λ₃, λ_{N-1}) fits the best.

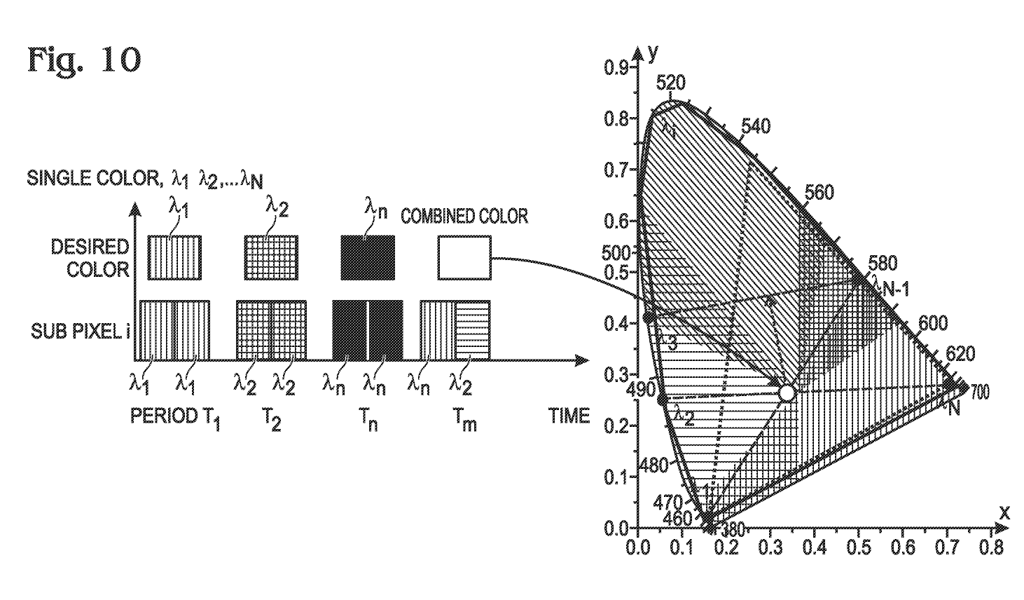

FIG. 10 is a diagram depicting the TDM mode of operation to generate primary and primary combination colors. In the first scenario (T1-Tn), a single primary color (λ₁, λ₂, . . . , λ_{N}) is generating by subpixel i by sequentially generating the primary colors in consecutive subfields. At time Tm, a primary combination color is generated by subpixel i by sequentially generating primary colors at the wavelengths of λ₂ and λ_{N}. In general, due to the nature of TDM, all the pixels have to be periodically tuned, even for static images. This leads to higher power consumption.

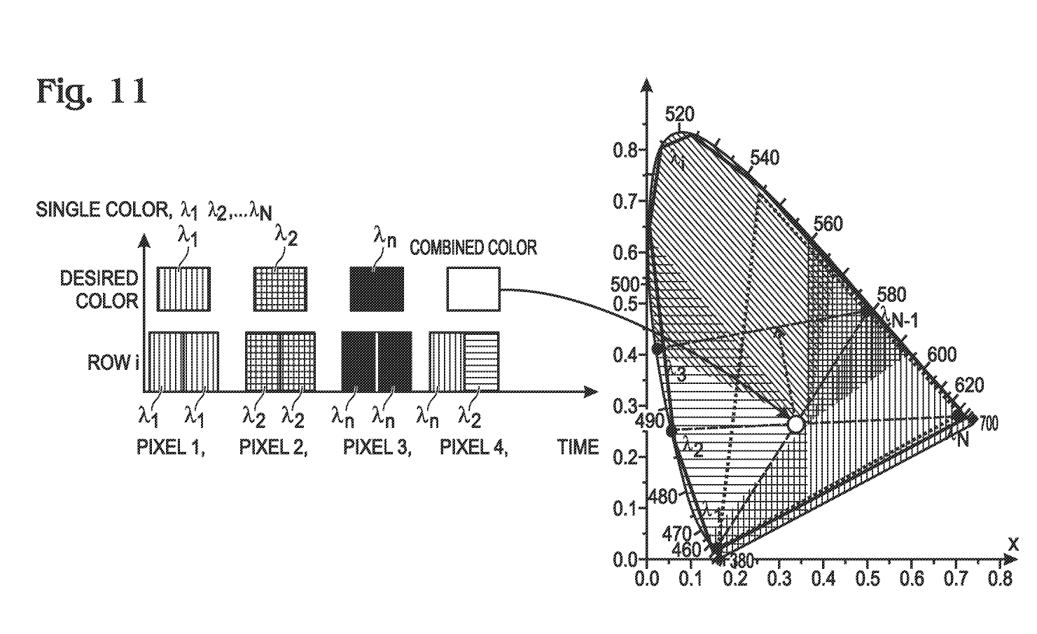

FIG. 11 is a diagram depicting the SDM mode of operation to generate primary and primary combination colors. Shown is row i of a display, with pixels 1 through 4. Each pixel includes 2 subpixels. In pixels 1-3, each set of subpixels simultaneously generate a common primary color, respectively, at wavelengths λ₁, λ₂, and λ_{N}. In pixel 4, the subpixels simultaneously generate primary colors at wavelengths λ₂ and λ_{N}, to create a primary combined color. The resolution of the colors at pixels 1-3 is as high as in TDM mode, but the resolution of the color created by pixel 4 is only half that of TDM mode. However, the combined color generated by pixel 4 can be fixed without periodic tuning, for low power consumptions, which is extremely helpful for hand-held book reader displays.

FIGS. 12A and 12B respectively contrast a 9-subpixel pixel with a conventional three-subpixel (RGB) pixel. Even if the pixel of FIG. 12A is used in the SDM mode, it has a higher resolution than the conventional pixel structure.

FIG. 13 is a flowchart illustrating a method for generating a full color gamut in a display device. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the steps are performed in numerical order. The method starts at Step 1300.

Step 1302 provides a display with at least one pixel, where each pixel includes a single subpixel. The subpixels may be a tunable plasmonic device or tunable interferometric modulation (MEMS) device. However, the method is applicable to any subpixel capable of generating more than one primary color. Using the single subpixel, Step 1304 sequentially generates a plurality of primary colors (e.g., at least 3 primary colors), where a primary color exhibits a single wavelength peak in the visible spectrum of light. Step 1306 supplies a gamut of colors including at least 3 primaries colors. When Step 1304 operates the subpixel in the TDM mode, Step 1306 is capable of supplying a primary combination color in response to the subpixel generating 2 primary colors in respective TDM subframes. As shown in FIG. 10, the TDM mode can also be used to generate a primary color.

In one aspect, Step 1302 provides a pixel with two (or more) subpixels. Then, Step 1305 operates the two subpixels in the SDM mode, and Step 1306 supplies primary combination colors in response to the first and second subpixels simultaneously generating primary colors in the SDM mode. As shown in FIG. 11, the SDM mode can also be used to supply primary colors.

Alternately, the two subpixels may be used in just the TDM mode. If Step 1302 provides a pixel with a first subpixel capable of sequentially generating at least 2 primary colors and a second subpixel capable of generating at least 1 primary color, then Step 1306 is capable of supplying a primary color combination in response to the first subpixel generating 2 primary colors in respective TDM subframes, or the first and second subpixels each generate a primary color in respective subframes.

If Step 1302 provides a pixel with both the first and second subpixels capable of sequentially generating 2 primary colors, then Step 1306 is capable of supplying a primary combination color in response to the first subpixel generating 2 primary colors in respective TDM subframes, the second subpixel generating 2 primary colors in respective TDM subframes, and the first and second pixels each generating a primary color in respective TDM subframes.

In addition to using the two subpixels in the TDM mode, Step 1305 may operate the two subpixels in a SDM mode, and Step 1306 additionally supplies a primary combination color in response to the first and second subpixels simultaneously generating a primary color in the SDM mode.

In one aspect, Step 1302 provides a display where each pixel has a control interface to receive framing signals, where each framing signal includes commands for selecting a subpixel primary color. Then, supplying the gamut of colors (Step 1306) includes the first and second subpixels generating a primary color in the SDM mode for a duration lasting a plurality of frames, in response to a single control signal.

A system and method are provided for creating a full color range display using multicolor subpixels. Explicit details of MEMS device structures have been used to illustrate the invention. However, the invention is not limited to merely this example. For example, plasmonic devices may be used as subpixels. Other variations and embodiments of the invention will occur to those skilled in the art.

We claim:

1. A multicolor display comprising:
at least one pixel supplying a gamut of colors including at least 3 primaries colors; and,
wherein each pixel includes a single subpixel capable of sequentially generating a plurality of primary colors, where a primary color exhibits a single wavelength peak in the visible spectrum of light.

2. The display of claim 1 wherein the subpixel is capable of sequentially generating at least 3 primary colors.

3. The display of claim 2 wherein the subpixel is capable of operation in a time division multiplex (TDM) mode; and,
wherein the pixel supplies primary combination colors in response to the subpixel generating 2 primary colors in respective TDM subframes.

4. The display of claim 1 wherein each pixel includes two subpixels, where at least one subpixel is capable of sequentially generating a plurality of primary colors.

5. The display of claim 4 wherein a first subpixel is capable of sequentially generating at least 2 primary colors and a second subpixel is capable of generating at least 1 primary color.

6. The display of claim 4 wherein a first subpixel is capable of generating 2 primary colors in respective TDM subframes and a second subpixel is capable of generating 2 primary color's in respective TDM subframes.

7. The display of claim 5 wherein the first subpixel is capable of operation in a TDM mode; and,
wherein the pixel supplies primary combination colors in response to the first subpixel generating 2 primary colors in respective TDM subframes.

8. The display of claim 7 wherein the second subpixel is capable of operation in a TDM mode; and,
wherein the pixel additionally supplies primary combination colors in response to an operation selected from a group consisting of the second subpixel generating 2 primary colors in respective TDM subframes, and the first and second subpixels each generating a primary color in respective TDM subframes.

9. The display of claim 5 wherein the first and second subpixels are capable of operation in a spatial division multiplex (SDM) mode; and,
wherein the pixel supplies primary combination colors in response to the first and second pixel elements simultaneously generating a primary color in the SDM mode.

10. The display of claim 9 wherein the second subpixel is capable of operation in a TDM mode; and,
wherein the pixel additionally supplies primary combination colors in response to an operation selected from a group consisting of the first subpixel generating two primary colors in respective TDM subframes, the second subpixel generating 2 primary colors in respective TDM subframes, and the first and second subpixels each generating a primary color in respective TDM subframes.

11. The display of claim 1 wherein the subpixel is selected from a group consisting of a tunable plasmonic device and a tunable interferometric modulation device.

12. The display of claim 1 wherein the pixel includes a control interface to accept framing signals, where each framing signal includes commands for selecting a subpixel primary color; and,
wherein the subpixel is capable of changing the primary color being generated in response to the framing signals.

13. The display of claim 12 wherein the pixel includes a first and second subpixel; and,
wherein the pixel supplies a primary combination color in response to the first and second pixel elements simultaneously generating a primary color in the SDM mode, over a time duration lasting a plurality of frames, in response to a single control signal.

14. A display device utilizing a method for generating a full color gamut, the method comprising:
proving a display with at least one pixel, where each pixel includes a single subpixel;
using the single subpixel, sequentially generating a plurality of primary colors, where a primary color exhibits a single wavelength peak in the visible spectrum of light; and,
supplying a gamut of colors including at least 3 primaries colors.

15. The method of claim 14 wherein sequentially generating the plurality of primary colors includes the single subpixel sequentially generating at least 3 primary colors.

16. The method of claim 15 wherein sequentially generating the 3 primary colors includes operating the subpixel in a time division multiplex (TDM) mode; and,
wherein supplying the gamut of colors includes supplying a primary combination color in response to the subpixel generating 2 primary colors in respective TDM subframes.

17. The method of claim 14 wherein providing the pixel includes providing a pixel including two subpixels; and,
the method further comprising:
operating the two subpixels in a spatial division multiplex (SDM) mode; and,
wherein supplying the gamut of colors includes supplying primary combination colors in response to the first and second subpixels simultaneously generating primary colors in the SDM mode.

18. The method of claim 14 wherein providing the pixel includes providing a pixel with a first subpixel capable of sequentially generating at least 2 primary colors and a second subpixel capable of generating at least 1 primary color; and,
wherein supplying the gamut of colors includes supplying a primary combination color in response an operation selected from a group consisting of the first subpixel generating 2 primary colors in respective TDM subframes, and the first and second subpixels each generating a primary color in respective subframes.

19. The method of claim 18 wherein providing the pixel includes providing a pixel with the second subpixel capable of sequentially generating 2 primary colors; and,
wherein supplying the gamut of colors includes additionally supplying a primary combination color in response to the second subpixel generating 2 primary colors in respective TDM subframes.

20. The method of claim 18 further comprising:
operating the two subpixels in a SDM mode;
wherein supplying the gamut of colors includes additionally supplying a primary combination color in response to the first and second subpixels simultaneously generating a primary color in the SDM mode.

21. The method of claim 20 wherein supplying the gamut of colors includes additionally supplying a primary color combination in response to the second subpixel generating 2 primary colors in respective TDM subframes.

22. The method of claim 20 wherein providing the display includes providing a display where each pixel has a control interface to receive framing signals, where each framing signal includes commands for selecting a subpixel primary color; and,
wherein supplying the gamut of colors in response to the first and second subpixels simultaneously generating a primary color in the SDM mode includes the first and second subpixels generating a primary color in the SDM mode for a duration lasting a plurality of frames, in response to a single control signal.

23. The method of claim 14 wherein providing the pixel includes a subpixel selected from a group consisting of a tunable plasmonic device and a tunable interferometric modulation device.
